(19) United States
(12) Patent Application Publication
(10) Pub. No.: US 2010/0178828 A1
(43) Pub. Date: Jul. 15, 2010

(54) Labor savors

(76) Inventor: Vicki Diane Garrison, Norwalk, CT (US)

Correspondence Address: VICKI DIANE GARRISON, 11 BOXWOOD ROAD, NORWALK, CT, 06851, US

(21) Appl. No.: 12/319,919

(22) Filed: Jan. 13, 2009

(51) Int. Cl. B32B 5/02

(52) U.S. Cl. 442/295; 442/301

(57) ABSTRACT

A ornamental two-dimensional flat woven fabric collection sheet for collecting leaves, grass and or debris. The flat woven fabric sheet is constructed of biodegradable natural fiber materials. Tying of the four (4) diagonal periphery corners of the substantially square-shape design in the center, forms the flat woven fabric collection sheet into a disposable all natural fabric bag encapsulating leaves, grass and or debris within an interior compartment therein.

### RELATED U.S. APPLICATION DATA

Continuation-in-part of application Ser. No. 12/319,919, filed on Jan. 13, 2009

### FIELD OF THE INVENTION

The present invention relates to a two-dimensional, biodegradable leaf, grass and or debris flat woven fabric collection sheet for the collection of leaves, grass and or debris raked, blown or place thereon. The leaf, grass and or debris flat woven fabric collection sheet when tied in the center from the four (4) diagonal periphery corners of the square-shaped design forms a disposable biodegradable fabric bag having leaves, grass and or debris encapsulated within an interior compartment therein.

### BACKGROUND OF THE INVENTION

Every year, autumn leaves fall and every spring, lawns need to be cut and various debris removed from beautiful homes and commercial businesses, creating many hours of energy and labor being exerted in the clean-up process. Each homeowner or gardener typically uses a blower or rake and non-degradable garbage bags to collect these leaves, grass and or debris, as this type of collection is very hard and time-consuming work. There remains a need for a biodegradable collection sheet that would help the homeowner or gardener to make the task of lawn maintenance easy and convenient. More particularly, a biodegradable leaf, grass and or debris flat woven fabric collection sheet that is very light in weight and degrades within weeks as apposed to the paper or plastic trash bags being used today that currently clutters our landfills for years to come.

### DESCRIPTION OF THE PRIOR ART

Leaf catching and collection devices, lawn debris devices, lawn nets and the like having various designs, structures, configurations and materials of construction have been disclosed in the prior art. For example, U.S. Pat. No. 5,092,681 to ASHLEY, III Drawstring Trash Container discloses a drawstring trash container which is characterized by a sheet of flexible, resilient material such as plastic having selected thickness and provided with peripheral loops, slits or a continuous channel for receiving a drawstring. The drawstring trash container is designed to be placed flat on the ground, loaded with trash such as leaves and the like, and the drawstring tightened in the loops, slits or channel to secure the trash in the resulting bag. The prior art patent does not disclose or teach the design, structure and configuration of the leaf/grass/debris flat woven fabric collection sheet of the present invention.

U.S. Pat. No. Des. 299,979 to GARRISON a grass/leaf collection sheet is an ornamental design for a grass/leaf collection with a pull cord attached to the outer periphery. Laid flat on the ground for leaves, grass and debris to be placed onto the sheet. Pulling its pull cord allows the periphery to encapsulate the debris, forming a bag for carrying and disposal. Made of non-degradable plastic. The prior art patent does not disclose or teach the design, structure and configuration of the leaf, grass and or debris flat woven fabric collection sheet of the present invention.

U.S. Pat. No. 4,602,664 to HULLEN discloses and apparatus for collecting lawn debris. Flat pieces of netting material are placed on the ground to catch leaves as they fall from nearby trees. When the leaves have fallen the net blanket is bundled up into a net package for disposal. The packages may or may not require a bag closure. A novel net bag closure for such packages is also disclosed. The bag closure also forms a handle for carrying the bundled leaf package. The net blankets may also be hung from trees to catch the leaves thereof before they reach the ground. The netting may be forded and then rolled into a hollow tube for merchandising, with accessories contained the hollow tube. The prior art patent does not disclose or teach the design, structure and configuration of the leaf, grass and or debris flat woven fabric collection sheet of the present invention.

U.S. Pat. No. 5,417,462 to HENSLEY discloses a lawn net for capturing and retaining lawn debris. The lawn net is positioned upon a lawn for collecting leaves thereon without harming the lawn. The device includes a netting material which may be left on the lawn for an extended period of time while leaves fall onto the net from surrounding trees. The net may be gathered together to enclosed the leaves by a use of a cord disposed along a periphery of the netting material. The net further includes a dispensing assembly for applying insecticide or fertilizer compounds to the lawn and is also provided with an adhesive applicator for applying an adhesive to the netting material prior to its placement upon the lawn. This prior art patent does not disclose or teach the design, structure and configuration of the leaf, grass and or debris flat woven fabric collection sheet of the present invention.

U.S. Pat. No. 5,744,212 to MEEKS discloses an apparatus and method for gathering and removing yard waste. The apparatus includes two parts, a laminar sheet and a plurality of spikes. The laminar sheet is placed on the ground and secured using the spikes. A number of apertures pierce the sheet to allow oxygen to aspirate the plant life below and to allow water from above to pass through. Clear plastic is preferably used to allow sunlight to reach the plant life, but other colors and materials are possible if so desired. After leaves, tree limbs, and the waste have accumulated on the sheet, the spikes are removed and the sheet and waste may be bundled together and discarded. This prior art patent does not disclose or teach the design, structure and configuration of the leaf, grass and or debris flat woven fabric collection sheet of the present invention.

None of these prior art patents teach or disclose the structure of a two-dimensional, biodegradable leaf, grass and or debris flat woven fabric collection sheet being tied at the center from the four (4) diagonal periphery corners encapsulating debris for transport and disposal.

Accordingly, it is an object of the present invention to provide a leaf, grass and or debris flat woven fabric collection sheet for the gathering of leaves, grass and or debris that forms a disposable, biodegradable woven fabric bag with all leaf, grass and or debris encapsulating within an interior compartment therein.

Another object of the present invention is to provide a leaf, grass and or debris flat woven fabric collection sheet that is made from all natural, biodegradable materials such as just, hemp, abaca, cotton, wood fibers plant fibers and combinations thereof.

Another object of the present invention is to provide a leaf, grass and or debris flat woven fabric collection sheet when in a fully assembled state wherein each of the fully assembled disposable woven fabric bags are stackable with each other.

Another object of the present invention is to provide a leaf, grass and or debris flat woven fabric collection sheet that is easy to assemble, tie and use for the gathering, transporting and disposal of leaves, grass and or debris.

Another object of the present invention is to provide a biodegradable leaf, grass and or debris flat woven fabric collection sheet that can be mass produced in an automated and economical manner and is readily affordable by the user.

### SUMMARY OF THE INVENTION

In accordance with the present invention, there is provided a two-dimensional leaf, grass and or debris flat woven fabric collection sheet for the collecting of leaves, grass and or debris. It is a modified but substantially square-shaped design constructed of biodegradable all natural woven fiber material. Tying of the four (4) periphery diagonal corners at the center of substantially square-shaped design, encapsulating leaves, grass and or debris within an interior compartment therein for transportation and disposal, wherein each of the disposable biodegradable woven bags are stackable with each other.

### BRIEF DESCRIPTION OF DRAWINGS

Further objects, features and advantages of the present invention will become apparent upon the consideration of the following detailed description of the presently preferred embodiment when taken in conjunction with the accompanying drawings, wherein:

FIG. 1 is a top plan perspective view of the leaf, grass and or debris flat woven fabric collection sheet of the preferred embodiment of the present invention showing the major component parts contained therein and in an assembled state being readied for operational use thereof; the flat woven fabric collection sheet of the present invention showing a modified but substantially square-shaped configuration of the flat woven fabric collection sheet, the bottom plan view being a mirror image of that shown.

FIG. 2 is a front side elevational perspective view thereof, the rear elevation view being a mirror image of that shown of the present invention.

FIG. 3 is a top perspective view of the leaf, grass and or debris flat woven fabric collection sheet of the present invention showing a multitude of leaves, grass and or debris having being raked or air blown onto the flat woven fabric collection sheet.

FIG. 4 is a top perspective view showing the tying (assembly) of two (2) diagonal periphery corners at the center location of the flat woven fabric collection sheet of the present invention.

FIG. 5 is a top perspective view showing the tying (assembly) of all four (4) diagonal periphery corners at the center location of the flat woven fabric collection sheet of the present invention.

FIG. 6 is a side perspective view of closed (assembled) woven fabric collection bag ready for transport and disposal of the present invention.

### DETAILED DESCRIPTION OF THE PREFERRED EMBODIMENT

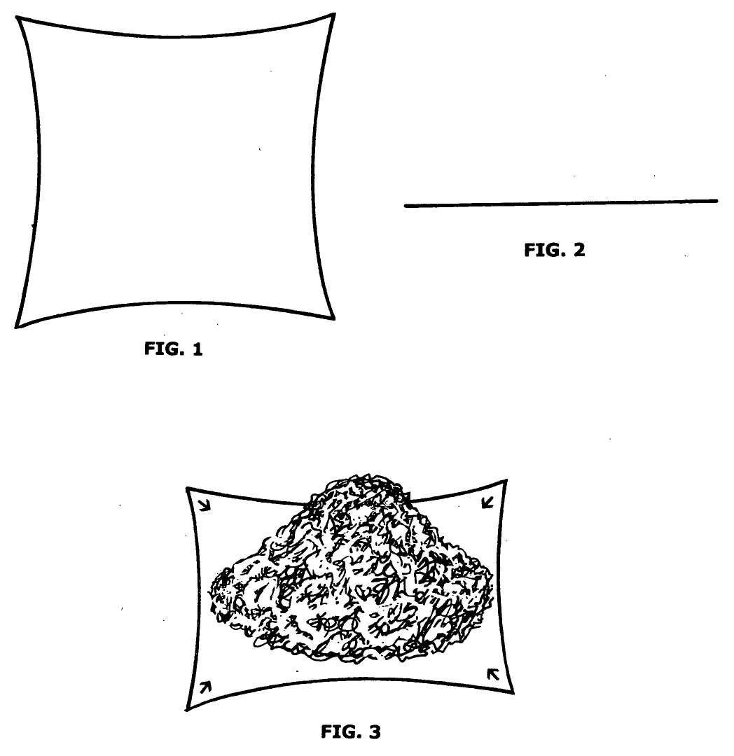

The biodegradable, two-dimensional leaf, grass and or debris flat woven fabric collection sheet 1 and its component parts of the preferred embodiment of the present invention is represented in detail by FIGS. 1 through 6 of the patent drawings. The biodegradable leaf, grass and or debris flat woven fabric collection sheet 1 is used for the collection, transportation and disposal of leaves, grass and or debris being collected on the lawn/ground of a user's home or commercial building property, etc.

As shown in FIGS. 1 through 3 of the drawings, the two-dimensional leaf, grass and or debris flat woven fabric collection sheet 1 includes a modified but substantially square-shaped flat woven fabric design.

The leaf, grass and or debris flat woven fabric collection sheet 1 is made from biodegradable fiber materials such as jute, hemp, abaca, cotton, wood fibers, plant fibers and combinations thereof. The biodegradability of the leaf, grass and or debris flat woven fabric collection sheet assures the leaf, grass and or debris woven fabric collection bag 6, after collection and brought to a compost heap, in which the leaf, grass and or debris woven fabric collection bag 6 will dissolve into mulch.

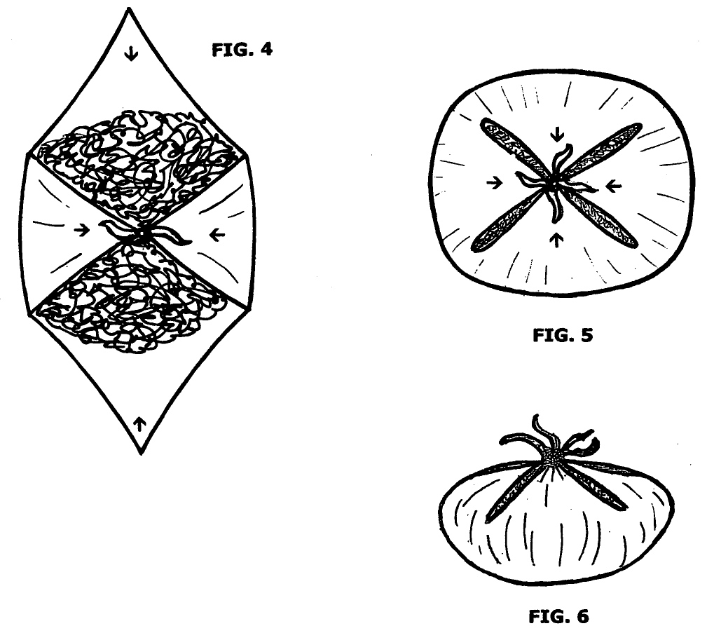

The modified but substantially square-shaped leaf, grass and or debris flat woven fabric collection sheet FIG. 1 is made in various sizes such as 4 feet by 4 feet and 8 feet by 8 feet. The 4 feet by 4 feet leaf, grass and or debris flat woven fabric collection sheet 1 has a 30 gallon capacity for holding approximately 30 pounds of leaves, grass and or debris within its interior compartment of the woven fiber disposable bag 6 when it is in fully assembled state, as shown in FIGS. 5 and 6 of the drawings. The 8 feet by 8 feet leaf, grass and or debris flat woven fabric collection sheet 1 has a 60 gallon capacity for holding approximately 50 pounds of leaves within its interior compartment of the woven fabric disposable bag FIG. 6 when it is in the fully assembled state, as shown in FIGS. 5 and 6 of the drawings.

In operating the leaf, grass and or debris flat woven fabric collection sheet of the present invention, as shown in FIGS. 1, the following operational steps are as follows. Initially, place the leaf, grass and or debris flat woven fabric collection sheet on the lawn/ground, air blow or rake leaves, grass and or debris onto the flat woven fabric collection sheet, as shown in FIG. 3 of the drawings.

The user now grabs two (2) diagonal corners and ties together in the center of the flat woven fabric sheet FIG. 4. User then ties the other two (2) remaining diagonal corners and ties them together in the center of the woven fabric sheet so that all four (4) corners are now tied in the center of the woven fabric sheet FIG. 5, forming a biodegradable disposable bag encapsulating leaves, grass and or debris within the interior compartment FIG. 6. The bag is now ready for disposal or collection by the municipal collection department.

### ADVANTAGES OF THE PRESENT INVENTION

Accordingly, an advantage of the present invention is that it provides for a biodegradable flat woven fabric collection sheet for the gathering of leaves, grass and or debris that forms a disposable bag encapsulating leaves, grass and or debris within an interior compartment therein.

Another advantage of the present invention is that it provides for a flat woven fabric collection sheet that is made from biodegradable materials such as jute, hemp, abaca, cotton, wood fibers, plant fibers and combinations thereof.

Another advantage of the present invention is that it provides the user with a light weight biodegradable alternative. By air blowing or raking piles of leaves, grass and or debris directly onto the flat woven fabric sheet will eliminate the time consuming practice of continued and repetitively bending over to pick up handfuls of leaves, grass and or debris and stuffing in conventional lawn and garden bags saving the user hours of back breaking time and exerted labor.

Another advantage of the present invention is that it provides when in a fully assembled state the disposable woven fabric bags are stackable with each other for easy collection by the municipal collection departments.

Another advantage of the present invention is that it provides for a collection device that is easy to assemble and use with only a four (4) step process; 1 lay collection sheet on lawn or ground, 2 rake or air blow leaves, grass and or debris onto the sheet, 3 tie two diagonal periphery corners at the center, 4 tie the other two diagonal periphery corners at the center and carry away.

Another advantage of the present invention is that it provides for a leaf, grass and or debris flat woven fabric collection sheet that can be mass produced in an automated and economical manner and is readily affordable by the user.

A latitude of modification, change, and substitution is intended in the foregoing disclosure, and in some instances, some features of the invention will be employed without a corresponding use of the other features. Accordingly, it is appropriate that the appended claims be construed broadly and in a manner consistent with the spirit of the invention herein.

1. An ornamental two-dimensional flat woven fabric sheet structure for collecting, transporting and disposing of leaves, grass and or debris.

2. An ornamental two-dimensional flat woven fabric collection sheet being constructed of biodegradable all natural fiber materials, wherein said biodegradable fiber material is selected from a group consisting of jute, hemp, abaca, cotton, wood fibers, plant fibers and combinations thereof.

3. An ornamental two-dimensional flat woven fabric collection sheet having a modified but substantially square-shape.

4. An ornamental two-dimensional flat woven fabric collection sheet when tied from the four (4) diagonal periphery corners at the center of said substantially square-shaped design of the flat woven fabric collection sheet forms a disposable woven fabric bag encapsulating leaves, grass and or debris within an interior compartment therein.

5. An ornamental two-dimensional flat woven fabric collection sheet wherein said substantially square-shaped woven fabric collection sheet is four (4) feet by four (4) feet in size having a 30 gallon capacity for holding approximately 30 pounds of leaves, grass and or debris.

6. An ornamental two-dimensional flat woven fabric collection sheet wherein said substantially square-shaped woven fabric collection sheet is eight (8) feet by eight (8) in size having an 60 gallon capacity for holding approximately 50 pounds of leaves, grass and or debris.
